(19) United States
(12) Patent Application Publication
(10) Pub. No.: US 2010/0023960 A1
(43) Pub. Date: Jan. 28, 2010

(54) Detection of Video Program Viewing Behavior for Correlation with Advertisement Presentation

(75) Inventor: Roie M. Hasson, North Attleboro, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/177,693

(22) Filed: Jul. 22, 2008

(51) Int. Cl. H04H 60/32

(52) U.S. Cl. 725/14

(57) ABSTRACT

A video user's viewing behavior with respect to video program selection is monitored. The monitored behavior is analyzed and a suitable advertising format for display that is related to the monitored viewing behavior is identified. Monitoring, for example, can include detecting channel surfing of available viewing channels, accessing and surfing through programming schedules, fast forwarding or reversing through a recorded program, and pausing display of a program.

### FIELD OF THE INVENTION

The present invention relates to display of video programs, more particularly to presentation of advertisement data identified in accordance with a user's viewing behavior.

### BACKGROUND

Commercial television has been dependent upon advertisement as a key revenue stream for its viability. Traditional television broadcasting techniques have been expanded to include digital signal format, transmitted via satellite, cable, telephone and internet connectivity. As digital video recorders have become more commonplace, television users frequently record their favorite shows and watch them at their convenience.

The recorded shows often are played at a fast forward speed through the commercials. Viewed at the fast forward speed, the advertisement content will not be fully comprehended. The commercial may be completely eliminated from viewing by directly advancing to the resumption of the recorded program. The robust capability of digital video recorders thus can decrease the revenue value of television advertising.

The advent of satellite and cable digital transmission systems has promulgated more sophisticated customer premises equipment (CPE), including receivers commonly known generically as “set-top boxes.” Such equipment allows the user to download program schedules for a great number of program channels. Users can channel surf through all available channels to view the schedule of current programming as well as the upcoming programming schedule for the channels in a future period. Channel and schedule surfing are often undertaken during commercial breaks, to the detriment of advertising value.

The need thus exists for presentation of advertising that is more likely to be viewed by the user. Provision of advertisement data when normal viewing is suspended.

### DISCLOSURE

The above described needs are fulfilled, at least in part, by monitoring a user's viewing behavior with respect to video program selection. The term “video” or “video data” as used throughout this disclosure is intended to include audio data as well as video data. Similarly, reference throughout the disclosure to display of video data is intended also to be applicable to presentation of audio content related to the video data. Monitoring, for example, can include detecting channel surfing of available viewing channels, accessing and surfing through programming schedules, fast forwarding or reversing through a recorded program, and pausing display of a program. Monitoring may also be applicable to determine the type of content of the displayed program.

The monitored behavior is analyzed and a suitable advertising format for display that is related to the monitored viewing behavior is identified. For example, if channel surfing or fast forwarding is detected, an advertising format that is effective for a short time period may be appropriate. Such a format may be in the form of a banner ad that is superimposed on a portion of the screen during the period of monitored behavior. If a pause function is detected, an advertisement may be selected that has content related to the content of the paused program. If a program is detected that is to be viewed continuously without commercial interruption, such as a sporting event, ads may be selected for presentation in the foreground or background of the display.

Viewing behavior is preferably monitored by one or more processors located at the customer premises. For example, monitoring may be performed at the video recorder and at the set-top box. Processing of the monitored data initiates selection of an appropriate advertisement from a plurality of stored advertisements. The advertisements may be stored locally at the customer premises and/or stored at a server at a remote head end location. The set-top may initiate a transmission to the server to download the identified commercial for display or selection of one or more locally stored commercials may be triggered. Locally stored advertisements may be updated with input received from the remote server from time to time.

Data representing monitored history of viewing behavior may be stored locally for the purpose of deriving viewing tendencies. Algorithms may be developed for aiding the process for selection of appropriate advertisements. For example an algorithm may dictate that there is a type of commercial format that is suitable for each viewing mode of the user. As a user changes from one viewing type to a more transitory viewing type, the suitable advertisement can be changed to accommodate the shorter viewing period. For example, channel surfing may be tracked and an advertisement may be selected that spans viewing types or bridges the short time spent performing multiple actions in a repetitive behavior. The pressing of the up key on the remote controller may trigger a request for a suitable advertisement. Such an ad may be played on a partial screen unobtrusively in the foreground as channels are being changed by the user in the background. The advertiser benefits from a captive user who does not miss viewing the programs being played.

As more monitored behavior is stored, viewing tendencies also can be developed with respect to the content of the programs selected by the user. Advertisements related in content can be identified for display. For example, the user may pause a live or recorded display of a soccer game. Such information can be communicated upstream to the server to identify stored advertisements having related content. The paused state may promulgate a decision to transmit to the user premises a full featured advertisement about upcoming soccer games in the area or about a soccer merchandise store.

Additional advantages of the present disclosure will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawing and in which like reference numerals refer to similar elements and in which:

FIG. 1 is a simplified block diagram of a television program distribution system.

FIG. 2 is a functional block diagram of consumer premises equipment in the system of FIG. 1.

FIG. 3 is a flow chart of one example of operation of the system of FIG. 1 in accordance with the present invention.

### DETAILED DESCRIPTION

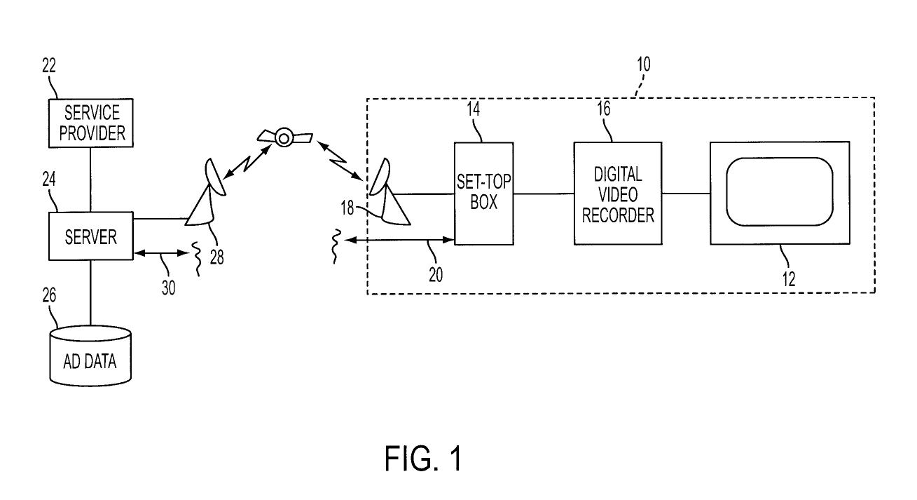

FIG. 1 is a simplified block diagram of a television program distribution system. Customer premises equipment (CPE) 10 is exemplified as including television coupled to set-top box 14 via digital video recorder (DVR) 16. Set-top box 14, as is well known in the art, contains processing capability for managing program viewing in response to user commands, as well as capability for transmitting and receiving data for television viewing. Any well known generic set-top box may be appropriate for the exemplified system. Data may be transmitted and received via satellite antenna 18 or via cable or other suitable connection 20. Connection 20 may comprise a telephone network connection having appropriate digital transmission capability.

The DVR 16 is a well known device that has the capability to record and store video programs and to apply video data for display at television 12. Such video data may be stored data or data received from set-top box 14. The DVR is responsive to user commands. Both the set-top box 14 and DVR 16 are responsive to user commands in well known manner, for example, by receipt of signals from one or more remote controllers. Command types include normal view, guide schedule view, pause, fast forward (at one or more speeds), rewind, channel change and channel change.

Service provider 22 may include a television service media provider and television broadcast system. As shown, the service provider is coupled to server 24 via a network connection. Alternatively the server can be incorporated within the service provider. Advertisement data are stored in database 26, which may be located remotely from the server or incorporated therewithin. The server 24 is shown coupled to satellite antenna 28 and connection 30 for data communication with CPE 10.

Server 24 includes sufficient processing capability to implement analysis and operation functions required for identifying appropriate advertisement data stored in database 26 in accordance with viewing behavior data received from the CPE client. The identified advertisement data is transmitted to the client in response to a received request. Server 24 can also provide updated advertisement data for CPE local storage.

Although the implementation is exemplified by client and server implementation, the disclosed invention is not limited to this implementation alone. The server is responsible for analyzing captured user behavior and determining the most suitable advertising format, for example, full length clip, static banner, dynamic moving banner, audio only, as well as the means of display on the user's television screen (including placement, overlay), ad duration, means of transmitting the ad to the used (such as in band, out of band) and any related interactive elements to be provided with the aid. The server receives requests form the CPE client based on the user's behavior. Once the server receives the client requests it parses the information and begins processing in order to find the most suitable ad format and means of display. The server may store these behaviors to build a history per CPE to help in better targeting and promotion of content or simply for analysis purposes. The server may be able to predict future behavior and create shortcuts that allow it to send predetermined ads at predetermined locations to speed up operation. For example, if the service provider would like to promote a new show with a simple banner ad, a shortcut bundle can be created that will cause, automatically and without analysis, the bundle to be displayed whenever fast forward behavior is detected.

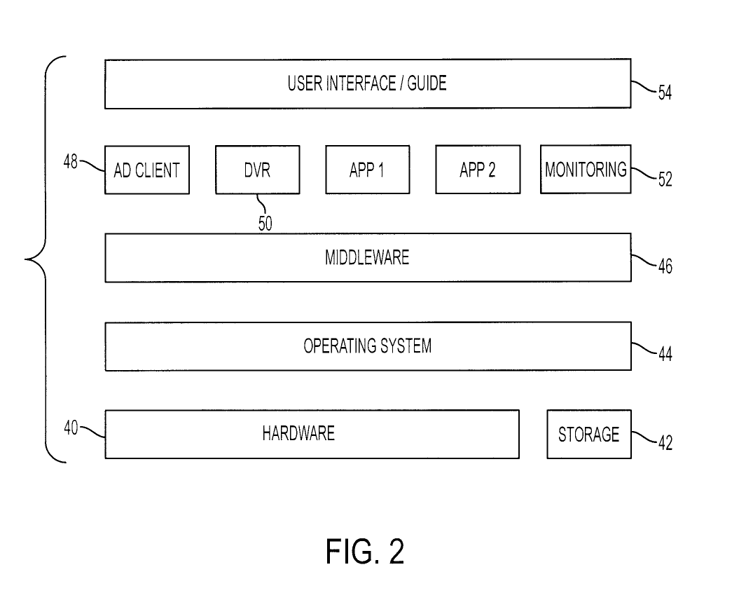

FIG. 2 is a functional block diagram of consumer premises equipment 10 in the system of FIG. 1. Hardware 40, which represents set-top box 14, DVR 16 and television 12, are operated under control of operating system 44. Middleware 46 interfaces controllers, such as ad client module 48, DVR module 50 and application modules 1-3, collectively referenced 52. One such application 52 provides a monitoring function. The monitoring application may receive an indication of the channel currently being displayed, a channel change operation, content being displayed on a channel from a channel map or guide information stored on the customer premises equipment, and DVR operation, such as a fast forward, pause, rewind or normal playback speed mode. The fast forward speed and/or rewind speeds being used being used may also be provided, such as ffx2, ffx4, rwx2, rwx4. The monitoring application may provide this collected information to ad client 48. User interface and guide block 54 represents interactivity with the user and program guide.

The CPE client is responsible for tracking viewing behavior. The client may also be provided with the capability for performing some of the analyzing functions discussed above that reside with the server. Viewing behavior is captured by the CPE client as the user navigates through channels, voice on demand (VOD) libraries, guide elements, or any other navigational elements that are part of the viewing experience. The client contains triggers that may guide it as to which behaviors to capture and which ones to send to the server. Alternatively, all behavior can be captured and sent to the server. For example, a trigger may be used to tell the client that when a user presses pause on the remote controller, such event requires notification to the server for determination of a suitable advertisement. As another example, entry by the user of a specific VOD library, such as action movies or search for a particular actor, would effect a trigger. The server can then identify an advertisement that is most appropriate to the viewer's behavior and that advertisement will be displayed at the most appropriate place and time. The advertisement could be a simple banner ad inserted into the VOD library user interface or an overlay on top of the screen to grab the user's full attention. An overlay may be in the form of a transparent or opaque display and or may be imposed on a resealed video program or inserted by a video replacement.

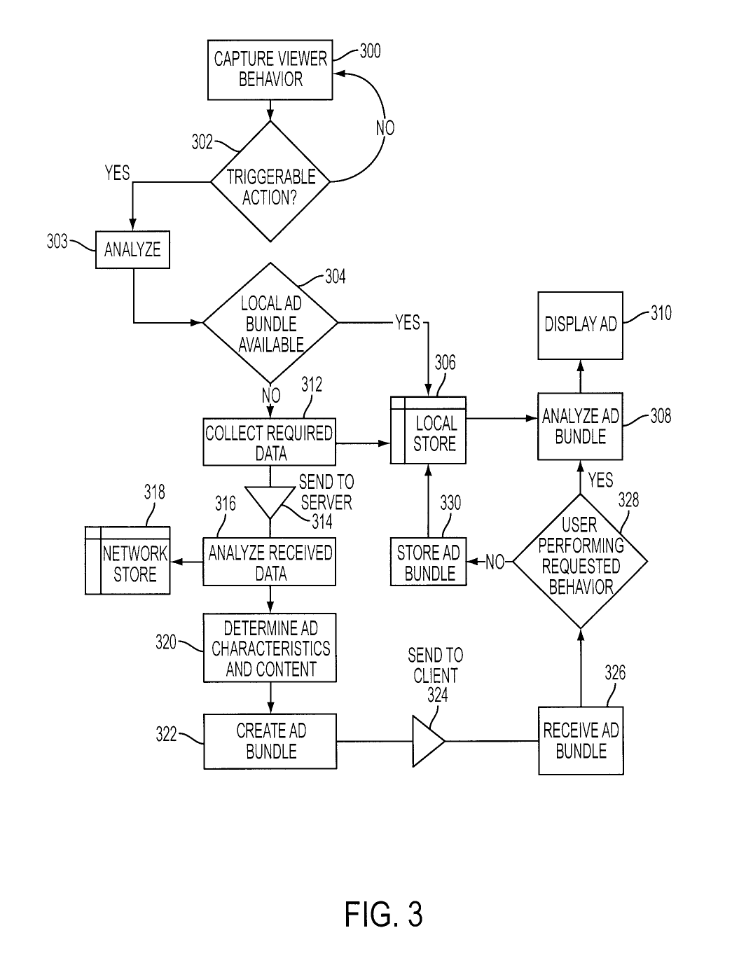

FIG. 3 is a flow chart representing one example of preferred embodiments for operation. At step 300, the processor at the consumer premises recognizes and captures viewer behavior. Such behavior would include channel and schedule surfing, and video recorder operations selected by the user. At step 302, determination is made whether the behavior captured in step 300 is appropriate to trigger action for presentation of an appropriate advertisement. If not, the flow reverts to step 300 to await detection of additional viewer behavior.

If it is determined in step 302 that an advertisement presentation is appropriate, monitored viewer behavior is analyzed at step 303 to identify suitable advertising format. The analysis may assess whether or not a locally stored bundle contains advertisements appropriate to the viewing behavior or related to subject matter content. For example, a sports related ad would be suitable for a sports program, a feminine hygiene ad may be suitable for a female oriented program, a children's ad for a children's program. An ad may appropriately correspond to a television program rating assigned by a program rating system, for example, “G” for general audience, “PG” for parental guidance. Information characterizing a program may be obtained from guide information or a program map stored in the consumer premises equipment. Additional sources of information for analysis may include key words in the title of the program or the type of program associated with a program title.

At step 304, determination is made whether a locally stored advertisement bundle is available. In response to a positive determination in step 304, the local store is accessed at step 306. Local store 306 may comprise any well-known computer-readable medium. At step 308, analysis is made of the stored advertisement bundle and an appropriate advertisement is selected for display at step 310. If it is determined at step 304 that there is no available advertisement bundle in local storage, data that are required for developing an appropriate advertisement library in local storage are collected at step 312. Such data may include the type of viewing behavior that was identified and the nature of viewing subject matter content, if available. The collected data may be transmitted to the head end server in real time or may be stored in local storage 306 for later transmission. Those of skill in the art will appreciate that the later transmission may occur during decreased usage times of the network to avoid bandwidth congestion.

At step 314, the collected data are transmitted by the set-top box to the head end server with a request by the CPE client to provide appropriate advertising data. At step 316, the server analyzes the received data and accesses storage for collected advertising data, at step 318. The advertising data storage may be located at the server and/or at a remote network location. At step 320, determination is made at the server of received advertising having characteristics and content, if appropriate, that is relevant to the viewing behavior data received from the CPE client. An advertisement bundle is then created at step 322 and transmitted to the CPE at step 324. Those of skill in the art will appreciate that the transmission may occur in real time or during decreased usage times of the network to avoid bandwidth congestion or at a time prior to when a user may be anticipated to perform a triggering event to insert an ad.

The advertisement bundle is received by the CPE at step 326. At step 328, determination is made as to whether the user is still performing the viewing behavior for which the request for advertising data was made. If so, the process flow reverts to step 308 for analysis with respect to the advertisement bundle received at step 326. If it is determined at step 328 that the viewing behavior has changed, the advertisement bundle received at step 326 is stored locally at step 330 for future use at step 306 and the process flow reverts to step 300.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein. For example, the concepts of the present invention are applicable to video program display for personal computers or handheld devices as well as for television viewing.

The term “computer-readable medium” as used herein refers to any medium that participates in providing instructions to a processor for execution. Such a medium may take many forms, including but not limited to non-volatile media, volatile media, and transmission media. Non-volatile media include, for example, optical or magnetic disks, such as a storage device. Volatile media include dynamic memory, such as main memory. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

What is claimed is:

1. A method comprising:
monitoring a user's viewing behavior with respect to video program data to be displayed;
analyzing the monitored behavior;
identifying a suitable advertising format to be displayed; and
displaying advertisement data in accordance with the identified advertising format.

2. A method as recited in claim 1, wherein the viewing behavior comprises channel surfing of available viewing channels.

3. A method as recited in claim 1, wherein the video data is prerecorded and the viewing behavior comprises video recorder usage.

4. A method as recited in claim 3, wherein the step of analyzing comprises determining whether viewing speed of the recorded video data is changed.

5. A method as recited in claim 3, wherein the step of analyzing comprises determining whether display of a video data sequence is paused.

6. A method as recited in claim 12, wherein the step of analyzing comprises determining whether display of a video data sequence is reversed.

7. A method as recited in claim 1, wherein the step of displaying comprises superimposing the advertisement data on displayed video data.

8. A method as recited in claim 1, wherein the step of identifying comprises selecting advertising content that is related to subject matter content of displayed video data.

9. A method as recited in claim 1, wherein the step of identifying comprises selecting a length of time for displaying the advertisement data.

10. A method as recited in claim 1, wherein the step of identifying comprises selecting the size of display of the advertisement data.

11. A method as recited in claim 1, wherein the step of identifying comprises selecting an advertisement from a plurality of stored advertisements.

12. A method as recited in claim 3, wherein the plurality of stored advertisements are stored proximate the video recorder.

13. A method as recited in claim 12, further comprising:
downloading the plurality of stored advertisements from a remote site; and
updating stored advertisements at appropriate times.

14. A system comprising:
customer premises equipment including a processor configured to:
monitor a user's viewing behavior with respect to program content of video data to be displayed at the premises,
analyze the monitored behavior, and
identify a suitable advertising format to be displayed that is related to the monitored viewing behavior.

15. A system as recited in claim 14, wherein the processor is coupled to a display for displaying program content and advertising content in the identified advertising format.

16. A system as recited in claim 15, wherein the customer premises equipment further comprises a video recorder responsive to user command operation and storage means coupled to the processor.

17. A system as recited in claim 16, wherein the processor is coupled to a video receiver operable by command of the user for selecting video content data input from a remote source.

18. A system as recited in claim 17, wherein the monitored viewing behavior comprises user command activation.

19. A system as recited in claim 16, wherein the storage means comprises recorded program data and advertising data, received from a remote site, and historical user command data.

20. A system as recited in claim 14, wherein the customer premises equipment is coupled to a remote server for storing therein viewer behavior history.
